(19) United States
(12) Patent Application Publication
(10) Pub. No.: US 2009/0154737 A1
(43) Pub. Date: Jun. 18, 2009

(54) APPARATUS, SYSTEM, AND METHOD FOR AN ENTERTAINMENT CHAIR

(75) Inventors: Jeffrey Ostler, Salt Lake City, UT (US); Jamie Beers, Salt Lake City, UT (US)

Correspondence Address: Kunzler & McKenzie, 8 EAST BROADWAY, SUITE 600, SALT LAKE CITY, UT, 84111, US

(73) Assignee: i-Fi Company, LLC, Salt Lake City, UT (US)

(21) Appl. No.: 12/337,538

(22) Filed: Dec. 17, 2008

Related U.S. Application Data
(60) Provisional application No. 61/008,064, filed on Dec. 17, 2007.

(51) Int. Cl. H04R 5/02

(52) U.S. Cl. 381/301

(57) ABSTRACT

An apparatus, system, and method for an entertainment chair provide a high fidelity audio system incorporated in an entertainment chair. The entertainment chair is relatively independent from an acoustical environment in which it is placed, and enables repeatable high fidelity sound with a wide variety of recording types and qualities. The entertainment chair has high transparency and excellent imaging. Mid-range speakers and/or tweeters are placed in or near the armrests, forward of the seat occupant, and are oriented to face inward and upward. In one embodiment the mid-range and/or tweeters also angle rearward. A subwoofer is placed in the backrest and a shaker is placed in the seat bottom. The subwoofer and shaker are separately tunable through a control panel ergonomically placed at a forward end of an arm rest. The control panel includes a universal iPod dock. Other inputs may also be connected to the entertainment chair.

### CROSS-REFERENCES TO RELATED APPLICATIONS

This application claims priority to U.S. Provisional Patent Application No. 61/008,064 entitled “APPARATUS, SYSTEM, AND METHOD FOR AN ENTERTAINMENT CHAIR”, filed on Dec. 17, 2007 for Jeffrey Ostler, which is incorporated herein by reference.

### BACKGROUND

1. Field

Embodiments of the invention relate generally to sound systems and more particularly relate to an entertainment chair that incorporates a high fidelity audio system.

2. Description of the Related Art

Sound systems have been added to chairs in the past. Speakers have been placed in backrests or on wings near a headrest portion of the chair. Gaming chairs have been developed that include shakers in the seat bottoms that are activated at relatively low frequencies. Some massage chairs also have audio systems incorporated to add to the relaxation and overall experience of a seat occupant.

While many of these chairs include features that increase the sensory experience of the seat occupants, they fall short in providing apparatuses, systems, and methods that provide a high quality audio experience. Often their presentation of audio is disjointed and/or veiled relative to what a real or live audio experience would be.

### SUMMARY

Conventional audio systems are subject to overlapping of vibrations and frequencies, which causes undesirable sounds and resolutions of sounds referred to as “overhang” that limit the enjoyment that is available to users of these chairs.

From the foregoing discussion, it should be apparent that a need exists for an apparatus, system, and method that is incorporated into a chair and provides a high quality of sound to a seat occupant. Beneficially, such an apparatus, system, and method would provide transparency and imaging such that the seat occupant can repeatably and easily imagine the real or live performance when listening to recordings of a large variety of types and qualities.

Embodiments of the present invention have been developed in response to the present state of the art, and in particular, in response to the problems and needs in the art that have not yet been fully solved by currently available audio or entertainment chairs. Accordingly, embodiments of the present invention have been developed to provide an apparatus, system, and method for presenting a high quality audio experience that overcomes some or all of the above-discussed shortcomings in the art.

The apparatuses include any combination of one or more features described herein and applied to an entertainment chair. Similarly, the systems may include any combination of features included herein and the term system denotes that two or more of the features function together. These features are set forth in the embodiments described below.

In one embodiment, a high fidelity audio chair includes a pair of chair arms, a speaker cabinet in each of the pair of chair arms, and at least one of a tweeter and midrange speaker in the speaker cabinet. In one embodiment, the speaker cabinet is configured to support the speaker with its face directed diagonally upward and inward in a plane adjacent to and in front of a seat occupant's face. In another embodiment, the speaker cabinet is configured to support the speaker with its face directed upward, inward and back generally at the seat occupant's face or specifically at the seat occupant's ears.

A high fidelity audio chair may include a speaker support configured to direct a face of a speaker at least one of upward and inward. In one embodiment, the speaker support is configured to also direct the face of the speaker rearward. In one embodiment, the speaker support is adjustable. In the adjustable embodiment, the speaker support may be adjustably mounted on an armrest of the chair. The speaker support may be pivotally supported on the arm for arcuate adjustment. The speaker support may be one of a pair of speaker supports, and speaker may be one of a pair of speakers. The chair may have the pair of speakers supported thereon. The chair may have an adjustable back rest. One or both of the speaker supports may be adjustable to generally maintain a relative position and/or orientation of the one or more speakers relative to the seat occupant's face.

In one embodiment, the speaker support is removably mounted on an armrest of the chair. An enclosure may be provided in the chair. Thus, the speaker support can be removably stowed in the enclosure for selective retrieval and deployment on the armrest of the chair. In one embodiment, there is a receiver on the armrest for receiving the speaker support in a deployed condition. One or more of a speaker, speaker cord, and jack may be supported on the speaker support. An electrical connector may be disposed on the armrest proximate to the receiver. The electrical connector may be configured to receive the speaker jack when the speaker support is in the deployed condition in the receiver. The speaker support may be a first speaker support having a first speaker supported thereon. As may be appreciated, a plurality of removable first speaker supports and speakers may be provided. On the other hand, the chair may additionally or alternatively include one or more second integral speaker supports that are integral with the armrests and that have one or more second speakers supported therein.

In one embodiment, a switching device may be coupled to at least one of the receiver and electrical connector. The switching device may be configured to be automatically activated when at least one of the first speaker supports is deployed. Deploying the removable speaker supports may include at least one of inserting the support into the receiver and inserting the jack into the electrical connector. The switching device may be configured to be automatically deactivated when at least one of the first speaker support is removed from the receiver and the jack is removed from the electrical connector. Thus, in one embodiment, the switching device connects the first speaker to a control system when the first removable speaker support is supported in the receiver, and the switching device connects the second integral speaker to the control system when the first speaker support is removed from the receiver.

In one embodiment, a high fidelity audio chair includes a backrest and a subwoofer in the backrest. The chair has a structure that includes a frame and a cushioning material. The structure forms a recess in the backrest, and the subwoofer is disposed in the recess. The face of the subwoofer is directed toward at least one of a trunk and a lower back of a chair occupant. In one embodiment, the frame includes a speaker cabinet in the backrest and the subwoofer is supported in the speaker cabinet. In one embodiment, little or no material is disposed between a face of the subwoofer and a seat occupant's body. For example, there may be an air space between the subwoofer face and a membrane forming upholstery or a seat cover. The upholstery or seat cover may have through openings that enable air to flow freely between the subwoofer face and the seat occupant's body. In another embodiment, the membrane forming the upholstery or the seat cover includes an active member of the subwoofer.

In one embodiment, a high fidelity audio chair includes a seat bottom. The chair may have a structure including a frame and cushioning material. A shaker is positioned in the seat bottom. In one embodiment, the chair includes one or more of tweeters and midrange speakers supported on the chair, a subwoofer in the backrest, and the shaker in the seat bottom for a 2.2 audio system. The shaker and the subwoofer may be separately tunable relative to each other. In one embodiment, the shaker and the subwoofer are each connected to a separate frequency range adjustment device and a separate volume control such that the shaker and the subwoofer are separately tunable and adjustable.

In another embodiment, a high fidelity audio chair has structure including a frame and cushioning material. The structure forms ergonomic armrests and hand rests. The ergonomic hand rest includes a docking station for a personal electronic device. The docking station has a platform or deck with an electronics connector supported on the platform. In one embodiment, the platform has a recess, and the electronics connector is disposed in the recess. In one embodiment, an adjustable support is coupled to the platform. In one embodiment, the adjustable support is slidably coupled to support any of a variety of personal electronic devices connected to the electronics connector. One or more of the recess, the electronics connector, and the adjustable support forms a generally cantilever support that orients and holds a personal electronic device in a generally upright position. The upright position includes extending upwardly and forwardly from the platform. In one embodiment, an iPod sync or electronics connector is disposed on a distal end of a flexible tether.

In one embodiment, the platform is adjacent to an upholstered portion of one of the armrests or hand rests of the chair. A cushioning material may include a stuffing material in the upholstered portion. The upholstered portion may form a rounded ergonomic hand rest that extends downward and forward to the platform. The chair may include controls disposed on the platform. The controls may include a shaker frequency range adjustment mechanism, a shaker volume adjustment mechanism, a subwoofer frequency range adjustment mechanism, and a subwoofer volume adjustment mechanism. The controls may also include one or more adjustment mechanism for other speakers and a mode selection mechanism. The mode selection mechanism may have a plurality of modes including personal electronic device, wireless, and auxiliary modes. Thus, the chair is capable of receiving signals from an iPod or other personal electronic device, receiving radio frequency or other signals from a transmitter associated with a television or other device, and receiving signals from another auxiliary device that can be plugged directly into the platform by a speaker jack or other connection that may be provided in the platform or elsewhere in the chair. The electronics connector and/or platform may thus be applied to a comfortable armchair or overstuffed chair or sofa that one might expect to find in a living room or family room.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any manner in one or more embodiments. One skilled in the relevant art will recognize that the embodiments of the invention may be practiced without one or more of the specific features or advantages of a particular embodiment. In other instances, additional features and advantages may be recognized in certain embodiments that may not be present in all embodiments of the invention.

These features and advantages of embodiments of the present invention will become more fully apparent from the following description and appended claims, or may be learned by the practice of embodiments of the invention as set forth hereinafter.

### BRIEF DESCRIPTION OF THE DRAWINGS

In order that the advantages of the embodiments of the invention will be readily understood, a more particular description of the embodiments of the invention briefly described above will be rendered by reference to specific embodiments that are illustrated in the appended drawings. These drawings depict only typical embodiments of the invention and are not therefore to be considered to be limiting of its scope. Nevertheless, the embodiments of the invention will be described and explained in greater detail through the use of the accompanying drawings, in which:

FIG. 1 is a perspective view of an embodiment of an entertainment chair in accordance with embodiments of the present invention;

FIG. 2A is a diagrammatic sectional view taken along line II-II of FIG. 1;

FIG. 2B is a diagrammatic perspective view showing an alternative embodiment of a shaker supported on a chair frame;

FIG. 2C is a diagrammatic partial side plan view of the entertainment chair of FIG. 1 in accordance with embodiments of the invention;

FIG. 3A is a diagrammatic partial sectional view taken along line III-III of FIG. 1;

FIG. 3B is a schematic side view of an entertainment chair having adjustable speakers in accordance with an embodiment of the invention;

FIG. 4 is a diagrammatic partial sectional view taken along line IV-IV of FIG. 1;

FIG. 5 is a rear plan view of the entertainment chair of FIGS. 1-3A and 4;

FIG. 6A is a detailed top plan view of a portion VI indicated in FIG. 1;

FIG. 6B is a diagrammatic sectional view taken along line VIB-VIB of FIG. 6A;

FIG. 6C is a diagrammatic top plan view of an alternative control platform;

FIG. 6D-6H are diagrammatic perspective views showing variations on control panel configurations and control panel locations;

FIG. 7B is a block diagram showing various elements that are interconnected to form a system that functions in a method in accordance with embodiments of the present invention;

FIG. 7B is a detailed perspective view of a portion VI indicated in FIG. 1, as viewed by a seat occupant; and

FIGS. 8A-8E are diagrammatic perspective views showing a variety of example speaker positions and combinations of positions in accordance with embodiments of the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described embodiments, features, structures, or characteristics of the invention may be combined in any manner and still remain within the spirit and scope of the embodiments of the present invention. In the following description, numerous specific details are provided, such as examples of user selections, structural variations, hardware modules, hardware circuits, hardware chips, etc., to provide a thorough understanding of embodiments of the invention. However, it is to be understood that the embodiments of the invention may be practiced without one or more of the specific details, or with other methods, components, materials, and so forth. In other instances, well-known structures, materials, or operations are not shown or described in detail to avoid obscuring aspects of the embodiments of the invention.

The personal electronic devices referred to herein may include one or more of an iPod, an iPhone, a personal digital assistant (PDA), an MP3 player, and other personal electronic devices. The electronics connector may include one or more of an iPod sync, an iPhone sync, a PDA sync, a connector for an MP3 player, and connectors for other personal electronic devices. The entertainment chairs referred to in embodiments of the present invention are also high fidelity audio chairs such that the terms “entertainment chair” and “high fidelity audio chair” may be used interchangeably.

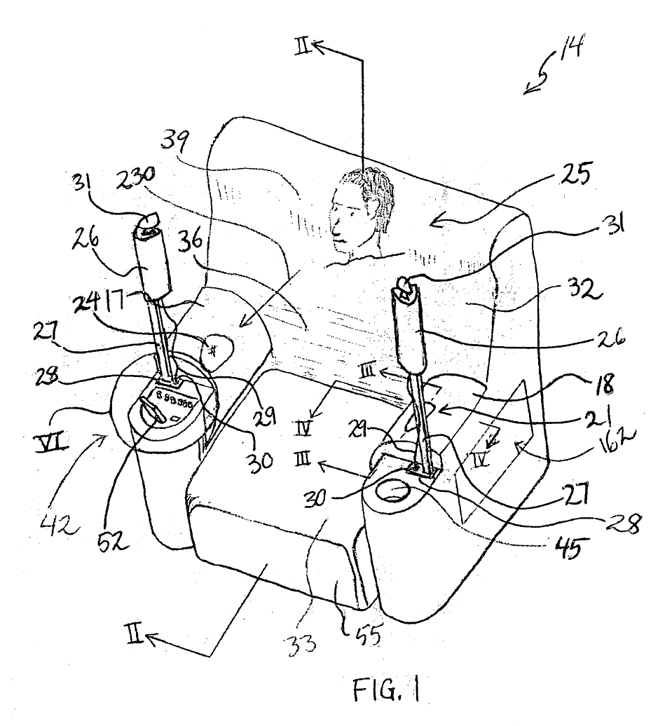

FIG. 1 is a perspective view of an entertainment chair 14 in accordance with an embodiment of the present invention. The entertainment chair 14 is a high fidelity audio chair that includes a pair of armrests or arms 17, 18, with a speaker unit 21 in each of the arms 17, 18. The speaker units 21 may have one or more speakers covered by a speaker cover 24 that may include a screen or other material with apertures to permit unrestricted flow of air between the speakers and an exterior of the speaker units 21. The speaker cover 24 generally defines a plane of the speaker faces of the speaker unit 21. In one embodiment, the speaker unit 21 is supported such that the faces of the speakers are directed diagonally upward and inward in a plane adjacent to and in front of a face 25 of a seat occupant. In some embodiments, the faces of the speakers may be directed in inward or upward directions.

The speaker units 21 may alternatively be supported to direct sound in planes that are near a face or ears of a seat occupant. For example a facing direction may be on a line that extends below, above, to either side, or otherwise rearwardly past the face and/or ears of the seat occupant. This may be accomplished with a fixed or adjustable frame.

FIG. 1 shows the relationship of the various components of the chair 14 as viewed from forward and above. In particular, FIG. 1 illustrates how the speaker units 21 lie in a vertical plane generally corresponding to section IV-IV that is slightly forward of a position in which a head 25 of a seat occupant would regularly be in an upright seated position. Alternatively, the speaker units 21 may be located in alignment with a position in which a head of a seat occupant would regularly be, or at any position along the arms. FIG. 1 also illustrates some of the details of the control platform 42.

In an alternative embodiment that is also illustrated in FIG. 1, satellite speaker units 26 may be supported at an elevated position on supports 27. The supports are removable received in receivers 28 in the armrests 17, 18. The satellite speaker units 26 are connected to a controller and the rest of the audio system through speaker cords 29 and jacks 30, which may be integrated with the supports 27 or may be separate. The receivers 28 may include openings for the supports 27 and/or the jacks 30. The satellite speaker units 26 may include any number of midrange and/or tweeter speakers that are integrated into one box or separately supported on the supports 27. For example speaker units 26 include a tweeter 31 atop a speaker box that contains one or more additional speakers.

The satellite speaker units 26 may be implemented in place of or in addition to the speaker units 21. The supports 27 may be selected to position the satellite speaker units 26 at or above a level of the face 25 of the user. Alternatively the speaker units may be located below the face 25 of the user. On the other hand, as the user reclines a backrest 32 of the entertainment chair 14, his/her face is lowered and the satellite speakers may then be positioned relatively higher than the face 25 and/or ears of the user. The satellite speaker units 26 may be angled to the rear and inwardly to face a location at or near the ears of the user. The system may be configured such that when the jacks 30 are plugged into the receivers 28, the satellite speaker units 26 automatically replace the speaker units 21 such that the controls adjust the speakers of the satellite speaker units 26 instead of the speaker units 21 that are supported directly in the armrests 17, 18. Alternatively, the satellite speaker units 26 may supplement the speaker units 21 and may be controlled by the same or separate controls as are the speakers in the speaker units 21. The satellite speaker units 26 allow for a greater distance between the speakers and the ears of the user, adjustability, and removability.

The entertainment chair 14 has the backrest 32 for supporting a back of a seat occupant and a seat bottom 33 for supporting the buttocks and legs of the seat occupant. The entertainment chair 14 may have a contoured surface including a lumbar support 36 and head rest 39 provided by a structure of the chair 14. The structure of the chair 14 may include a frame and cushioning material configured to provide an ergonomically comfortable chair. A control panel or platform 42 may be provided at a front end of one of the arms 17 and a drink holder 45 may be provided at the front end of the other of the arms 18. As shown, the receiver may be positioned on or near the platform 42 on the arm rest 17 and at an analogous position on the other arm rest 18. The control panel or platform 42 may be alternatively positioned at any location on the chair, without limitation.

FIG. 1 also shows a rounded configuration of a cushioned portion of the armrests or arms 17, 18, which includes arcs that protrude upward and inward toward a center of the chair 14 in which the center of the chair is generally defined by a section II-II. Alternative cushioning configurations are also available, including pillow top cushioning, for example. FIG. 1 shows how a personal electronic device 52 extends in a generally upright cantilevered position from the platform 42, which is positioned forward of the cushioned portion of arm 17. On the other hand, it is to be understood that the personal electronic device 52 may be supported at any other location and in any other orientation without limitation.

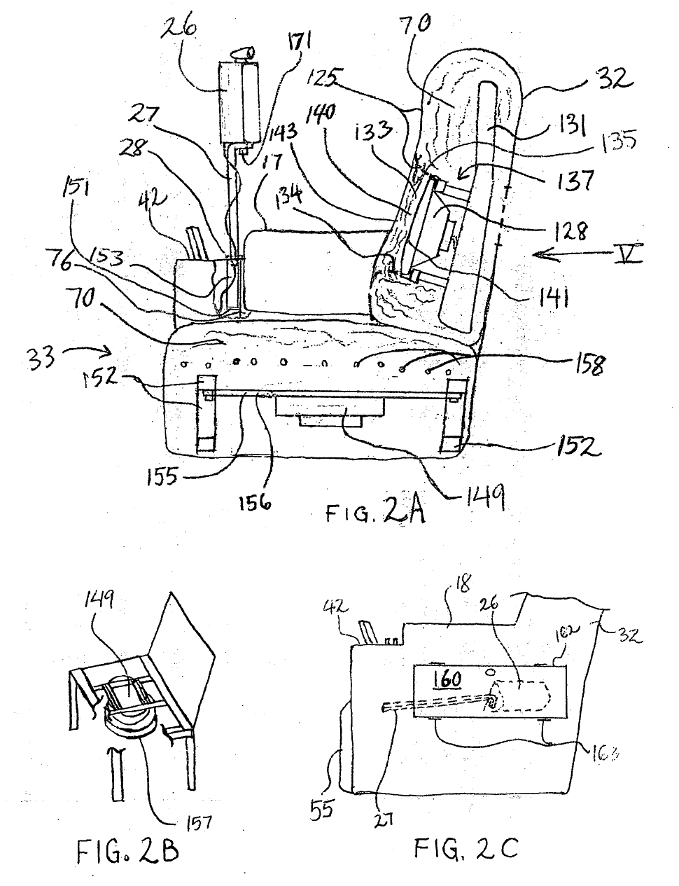

FIG. 2A is a diagrammatic sectional view taken along line II-II of FIG. 1 showing features inside the entertainment chair backrest 32 and seat bottom 33. The backrest 32 has a subwoofer speaker 128 (hereinafter also “subwoofer”) disposed in the backrest 32. The chair 14 has a structure that includes a frame 131 and a cushioning material 70 in the backrest 32. In one embodiment, the structure forms a recess 133 in the backrest 32, and the subwoofer 128 is disposed in the recess 133. In FIG. 2A, the recess is shown between dashed lines 134, 135, indicating that the recess is an optional configuration. The structure supports the subwoofer 128 such that a face of the subwoofer 128 is directed toward at least one of a trunk and a lower back of a seat occupant. The frame 131 may include a speaker cabinet 137 with the subwoofer 128 supported in the speaker cabinet 137. The speaker cabinet 137 may be formed of a box or other structure. Other speakers and transducers are supported in the chair 14 to be disposed in particular relation to a body of a person seated in the chair. By positioning the transducers in this way, the chair 14 actually becomes an overall speaker cabinet of a set of speakers or transducers. Additionally, the chair 14 supports the electronics and the controls of the audio system such that the overall speaker cabinet formed by the chair 14 houses speakers, subwoofer(s), shaker(s), electronics, controls, and provides a body support for a user. Beneficially, the chair 14 generally locates the body of the user for the best and most transparent audio experience. Furthermore, adjustment of at least some of the transducers may be undertaken to maximize the audio experience.

In one embodiment, little or no material is disposed between a face of the subwoofer 128 and a body of the seat occupant. For example, there may be an air space in the recess 133 between the subwoofer face and a membrane 143 that spans the recess 133. The membrane 143 may simply be a portion of the upholstery 125 covering the chair 14, or may be formed of an additional sheet of material, which may be extremely flexible or flaccid. On the other hand, the membrane 143 may be only slightly flexible or even rigid. The membrane 143 may have through openings 146, as shown in FIG. 1. The through openings 146 enable air to flow freely between the face of the subwoofer 128 and the body of the seat occupant. Thus, aside from any clothing covering the seat occupant, the body of the seat occupant can thus be in fluid communication with the subwoofer 128. This, along with other features described herein, has the effect of helping to remove the veil that often exists in sound systems. Thus, the sound system of the embodiments of the present invention presents an unveiled or unmasked audio experience.

In other embodiments a material 140 may be disposed in the recess 133. However, the material disposed in the recess 133 may be a material that does not interfere or only interferes minimally with sound that is emitted from the speaker(s). The material 140 may be the same as the material 70 utilized to stuff other portions of the chair and may be separated from the active member of the subwoofer by a barrier 141 of speaker cloth, for example.

In an alternative embodiment, the subwoofer 128 or an analogous transducer is brought forward so that its face is substantially at the plane of a front surface of the backrest 32. The subwoofer 128 or other transducer, in this embodiment, is modified to include the membrane 143 as an active member of the subwoofer 128 or as an active member of another transducer utilized in place of the subwoofer 128. Thus, in this alternative embodiment, the subwoofer 128 or other transducer directly vibrates the membrane 143 that is in contact with the seat occupant.

FIG. 2A also shows a shaker 149 disposed in the seat bottom 33. The seat bottom 33 has a structure including a frame 152 and cushioning material 70. The shaker 149 is secured in the seat bottom 33. With the placement of the subwoofer 128 in the backrest 32 and the shaker 149 in the seat bottom 33, the vibrations from the base frequencies are felt and/or experienced by the body of the seat occupant while the tweeters and/or mid-range speakers 82, 83 are positioned for presenting the higher frequency sounds to the ears. In embodiments in which the chair 14 has one or more of tweeters and midrange speakers 82, 83 supported on the chair 14, the subwoofer 128 in the backrest 32, and the shaker 149 in the seat bottom, a 2.2 audio system is provided. Furthermore, the lower frequencies are directed to the trunk and upper legs of the seat occupant. Thus, frequencies that are felt as much or more than they are sensed by hearing are more realistically presented to the seat occupant. This and other features help to make the entertainment chair 14 a high fidelity audio chair that produces sound of extremely high quality with high levels of transparency and imaging. Furthermore, the shaker 149 and the subwoofer 128 are separately tunable and adjustable, as described below.

FIG. 2A also shows a cutaway portion of the arm rest 17 below the platform 42. Within the arm rest 17, a bracket 153 is aligned with an opening in the receiver 28 at or near the platform 42. Alternatively, the receiver 28 may be located at any position on the arm rest 17 and/or other places on the chair 14. The bracket 153 is attached to a frame member 76. The bracket 153 receives the support 27 and has an end wall 151 that acts as a stop for the support 27 when it is fully inserted into the receiver 28. Thus, one or more satellite speaker units 26 may be supported on the chair 14.

In alternative embodiments, tweeter and midrange speakers may be included at locations and/or may have orientations directing their sound to the trunk or other parts of a body of a seat occupant. Similarly, subwoofers and shakers may be placed to convey their vibrations to a head, face, ears, or limbs of a seat occupant, without limitation. The locations for speakers and speaker units illustrated in the drawing figures may have any transducer or speaker capable of transmitting vibrations in any range of frequencies. These speakers or transducers may alternatively be positioned in other locations relative to the chair and oriented in other directions than those shown.

Other features also aid in producing a high quality of audio and other sensory vibrations. For example, a vibration attenuation mass may be provided at least in part by an attenuation member or attenuator 155 that is connected to the shaker 149 for attenuating and/or transferring vibrations relatively quickly after the shaker 149 has produced the vibrations. The attenuation member 155 is also coupled to the frame 152 of the chair 14 such that the vibration attenuation mass also includes at least a portion of the chair frame 152 and/or other structure of the chair. The connection between the shaker 149 and the attenuation member 155 is direct and rigid so that a large percentage of the vibrations produced by the shaker 149 propagate into the attenuator 155.

In one embodiment, the vibration attenuation member 155 includes a plate 156 of at least partially flexible material coupled to the shaker 149. The plate may be formed of metal and may function as a relatively stiff spring that flexes at least slightly yet absorbs vibrations quickly. In one embodiment, the vibration attenuation mass 155 may be formed predominately of a homogeneous material and/or may include tightly coupled elements as opposed to being formed of a combination of loosely connected members that may have a large variety of resonance and/or damping characteristics. The vibration attenuation mass 155 and its connections are configured to more accurately simulate a natural presentation of vibrations that would be felt by the occupant through an environment and objects in that environment in a real or live setting. As such, the vibration attenuation mass 155 does not overly dampen the vibrations. Rather it provides a natural attenuation. Thus, the vibration attenuation mass 155 can provide a tighter transmission of the lower frequency vibrations, which transmission remains more true to the signal from which the vibrations are derived 155 includes the plate 156 of material that may have a size extending a major portion of a width of the seat bottom. This has the effect of increasing the size of the transducer or shaker 149, and spreads the shaking from the transducer or shaker 149 over a broader area of the seat bottom 33 and the chair 14 overall.

FIG. 2B is a diagrammatic cut away perspective view of an alternative embodiment for the shaker. FIG. 2B shows that the vibration attenuation mass may include frame members or other members of the chair itself to which the shaker 149 is attached. In a further option or alternative embodiment, the shaker 149 may be attached to a vibration attenuation mass 157 that is also shown FIG. 2B. The vibration attenuation mass 157 may be of any shape and size and may be unattached relative to other structure of the chair. Thus, the attenuation mass 157 is only attached to the chair via the shaker 149 such that the mass 157 is free to move unencumbered except by the forces of the shaker 149 when it vibrates. Further alternatives include attaching the attenuation mass 157 to other members of the chair or to materials with particular attenuation properties. Still further, the shaker itself may be attached to materials that have particular attenuation properties. The materials may include but are not limited to one or more of liquids such as water, gels, rubbers, and plastics.

The plate 156 of material may be formed of metal and have a relatively large mass compared with a mass of the shaker 149. In one embodiment, the cushioning material 70 includes springs 158 in the seat bottom. The plate of material is coupled to the springs 158 by any of a variety of fasteners. In one embodiment, the plate of material is coupled to the springs 158 by an interleaved configuration in which the plate of material extends between respective springs 158 or portions of one or more springs 158.

FIG. 2C is a side plan view of the entertainment chair 14 of FIG. 1 in accordance with an embodiment of the invention. The backrest 32 may be of the reclining type. Also, a front portion 55 of the seat bottom 33 may form a retractable foot rest and/or leg rest. As may be appreciated from FIGS. 1-4, the chair 14 may be of the overstuffed or cushioned arm chair type that incorporates one or more of a variety of springs, foam, stuffing and/or other cushioning materials. Alternatively, the chair may be any of a variety of chairs including but not limited to a folding chair, an office chair, a massage chair, a gaming chair, and a motor vehicle seat.

As shown in FIGS. 1 and 2C, a chair 14 may include a compartment 162 covered by a door 160, for example. The compartment 162 may be closed by a removable piece or by a portion of the arm rest that is pivoted on a hinge 163, for example. As shown in FIG. 2C, a chair may include the compartment 162 in order to provide storage space for the speaker units 26 and/or supports 27 (shown schematically as hidden within in dashed lines). The door 160 may have one or more hinges 163 to enable the door 160 to swing open. The compartment may alternatively be accessed by a removable piece or by a portion of a pillow top or other cushioning member, which may have a hinge. In one embodiment, the hinges may take the form of living hinges. The speaker support 27 and the satellite speaker unit 26 can be stowed in the compartment 162 and may be retrieved and assembled for deployment in a one or more position of use. An example of one position of use is shown with the supports 27 inserted at a connecting point or receiver 28 on an outer surface of the arm in FIGS. 1 and 2A. The speaker support may alternatively be supported at different locations on the chair.

FIGS. 1 and 2C show an example in which the speaker units 26 and/or compartment(s) 162 may be provided in addition to or instead of the speaker units 21. In the example of the compartment shown in FIG. 2C, the compartment 162 is closed with the speaker unit 26 and speaker support 27 stowed. As shown in FIGS. 1-2A and 2C, the speaker support 27 may have one piece with connector elements 171 that are static or adjustable for connection to the chair 14 and to the speaker units 26. The connector elements 171 may take the form of a finger nut that enable the speaker units 26 to be rotated to face a head and/or ears of an occupant of the chair 14 when the connector elements are loosened. Then the connector elements may be tightened to hold the speaker units 26 in place. Alternatively or additionally, the connector elements can be adjustable by one or more of linear and pivotal adjustment mechanisms to enable one or more of height, width, fore, and aft adjustments by linear and/or angular adjustment mechanisms.

In alternative embodiments, the speaker supports may have a plurality of pieces that are separable and/or adjustable relative to each other. The speaker units may be static or adjustable relative to the speaker supports. The speaker supports may be supported at different locations on the chair. Although the compartment 162 is shown only on the left arm of the chair 14 in FIGS. 1 and 2C, it is to be understood that similar compartments with respective speaker supports and speakers may be applied to both arms and/or other spaces within the chair. Further alternatively, the plural supports and/or plural speaker units 26 may be stowed in a single compartment 162.

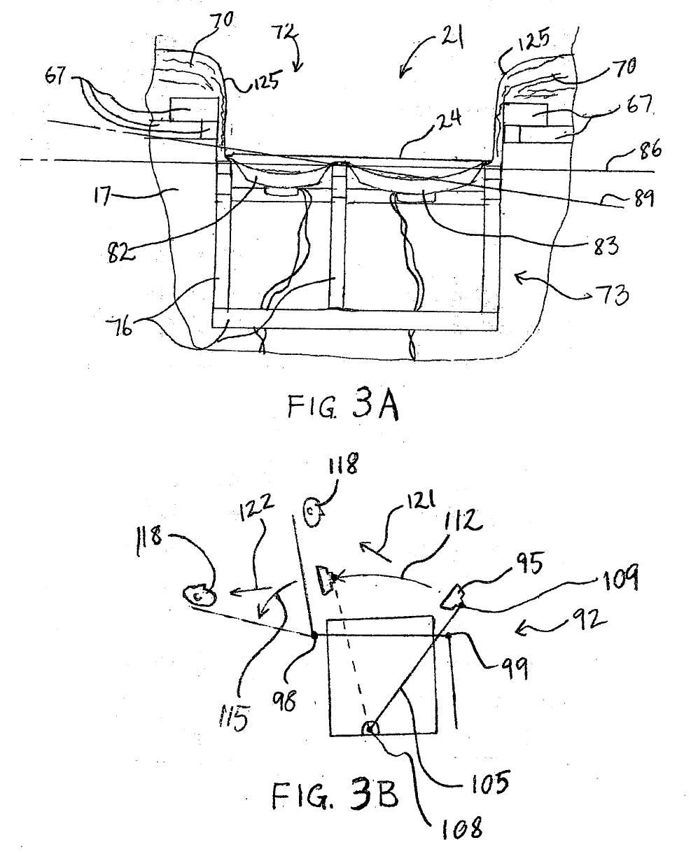

With an overview of basic components of the entertainment chair 14 set forth above, the disclosure is now directed to several details of embodiments of the invention in which FIG. 3A is a diagrammatic partial sectional view taken along line III-III of FIG. 1. Structure in the arm 18 includes frame members 67 and cushioning material 70. The structure may help to form a recess 72 in the armrest. Alternatively, the speaker units 21 may be generally mounted flush with the outer surface of the arms 17, 18 of the chair 14. A speaker cabinet 73 in each of the pair of chair arms 17, 18 supports the speaker units 21 in the recess 72 or in a flush mounted position. The speaker cabinet 73 may be formed by cabinet frame members 76 similar to the frame members 67 that form the arms 17, 18 and other portions of the chair 14. Alternatively, other structure such as a box may provide the speaker cabinet 73.

As shown in FIG. 3A, the speaker cover 24 is generally co-planar with or parallel to faces of at least one of a tweeter speaker 82 and a midrange speaker 83. Alternatively, the speaker cover 24 and/or the speaker unit 21 may be mounted substantially flush with an outer surface of the arms 17, 18. One or more of the tweeter and midrange speakers 82, 83 make up the speaker unit 21 that is supported in the speaker cabinet 73. In one embodiment, the speaker cabinet 73 is configured to support the speakers 82, 83 such that they face upwardly, inwardly, and in a plane perpendicular to a horizontal axis 86. In another embodiment, the speaker cabinet 73 is configured to support the speakers 82, 83 with their faces directed upwardly, inwardly, and rearwardly generally toward the face or ears of a seat occupant. This direction is in a plane perpendicular to an axis 89, and may be adjustable in some embodiments.

FIG. 3B is a schematic side view of an entertainment chair 92 having adjustable speaker units 95 in accordance with one embodiment of the invention. The entertainment chair 92 may be adjustable by pivots 98, 99. The adjustable speaker unit 95 may be adjustably supported on an arm 102 by a speaker support 105 and pivots 108, 109. By providing similar speaker supports 105, pivots 108, 109, and speaker units 95 on both arms 102, the entertainment chair 92 can be configured as a high fidelity audio chair. The speaker support 105 and pivots 108, 109 can be configured to direct faces of the adjustable speaker units 95 at least one of upward and inward similar to the embodiments described above. Also, the speaker support 105 can direct the face of the adjustable speaker units 95 rearward.

As shown by arrow 112 in FIG. 3B, the speaker support 105 may be pivotally supported on the arm 102 or another portion of the chair 92 for arcuate adjustment. When the chair 92 has an adjustable backrest, as indicated by arrow 115, one or both of the speaker supports 105 may be adjustable to generally maintain a position and/or orientation of the one or more speaker units 95 relative to the face 118 of a seat occupant. At least, the adjustable speaker units 95 can be adjusted to face a direction of the face 118 or ears of the seat occupant, as indicated by arrows 121, 122. Alternatively, other adjustment mechanisms may be implemented. For example, slidable mechanisms, telescoping mechanisms, and/or linkage mechanisms may be used to support speaker units 95. It is to be understood that the speaker supports 105 and adjustable speaker units 95 described with regard to this embodiment may be applied additionally or alternatively to the other embodiments of entertainment chairs 14 described herein. Furthermore, the features described in the other embodiments may be applied to the embodiment of FIG. 3B without limitation.

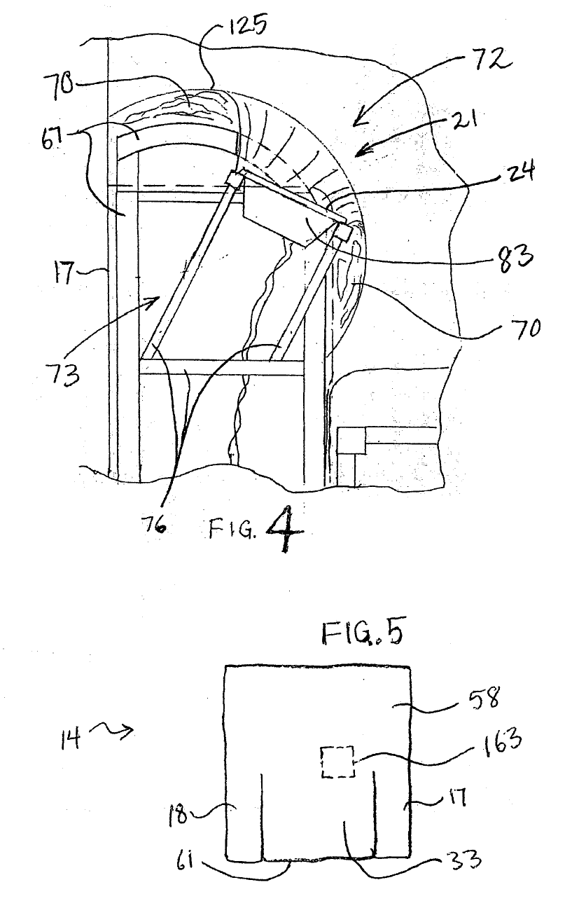

FIG. 4 is a diagrammatic partial sectional view taken along line IV-IV of FIG. 1. This view further elucidates structure and details discussed with regard to FIG. 3. The plane of section IV-IV is perpendicular to the plane of the section of FIG. 3. FIG. 4 shows the cushioning material 70 and the frame members 67 forming the armrest or arm 17. FIG. 4 further illustrates structure in the arm 17 that forms the recess 72. The recess 72 is formed in part by the cushioning material 70. The recess 72 is also formed, at least in part by the speaker cabinet 73. The speaker cabinet 73 may be formed in part by frame members 67, and by the cabinet frame members 76. As may be appreciated, the cabinet 73 may be formed to present the speaker units 21 and speaker cover 24 in a generally flush mounted position relative to an outer surface of the chair arms 17, 18. The inward and upward angle of the speaker cabinet 73, and the resultant supported orientation of the face of the speaker 83 in an inward and upward direction is clearly shown in FIG. 4. One or more speakers 82, 83, or the pairs of speaker units 21 may be placed in respective arms 17, 18. The speakers 82, 83 may be balanced in positions and orientations relative to a position of a face of a seat occupant.

Little or no material is disposed between a face of the speaker 82, 83 and a face of a seat occupant. For example, as shown in FIGS. 3A and 4, a seat covering or upholstery 125 may end at an edge of the speaker units 21 and/or at an edge of the recess 72 so that a single opening is formed around the speaker unit 21. The cover 24 permits free passage of air therethrough, as discussed above. In an alternative embodiment, the upholstery 125 may extend over the recess 72, and there may be an air space between the speaker face and a portion of the upholstery 125 covering the recess 72. The portion of the upholstery 125 may have through openings that enable air to flow freely between the speaker face and the face of the seat occupant in a configuration similar to the embodiments of the recess 133 and speaker 128 shown and described with regard to the backrest 30 in FIGS. 1 and 2A. In one embodiment, the recess 72 may have a material therein. In one embodiment, a material that causes minimal interference with the vibrations being emitted from the speaker(s) is disposed in the recess 72.

FIG. 5 is a rear plan view of the entertainment chair 14 of FIG. 1 in accordance with an embodiment of the invention. The backrest 32 is part of a seat back 58 that is viewed from a rear of the chair 14. The seat back 58 is connected to the arms 17, 18 that are shown extending to a ground level. Alternatively, the seat back 58 may be connected directly to the seat bottom 33. The arms 17, 18 straddle the seat bottom 33. The seat bottom 33 may have a panel of material or door 61 that can be opened to access components inside the chair 14. For example, the components may include at least one of a transformer, speaker(s) and shaker(s). The speakers and other components may alternatively be accessible through other surfaces of the chair.

FIG. 5 also has a porthole 163 of speaker cloth or other material that does not inhibit or only minimally inhibits transmission of air and sound waves through the cover of the chair 14. The porthole 163 may have a color and/or texture that is similar to the rest of the cover material or upholstery on the chair so that it is not visible or only minimally visible to an observer. On the other hand, the porthole 163 has the effect of enabling air to move out of the seat back 58 from a back side of the subwoofer 128. In this way, the seat back 58 may be completely enclosed and still allow air to move back and forth through the porthole 163. This configuration enables production of lower bass sounds with less power.

It is to be understood that a chair in accordance with the embodiments of the present invention may take any form including, but not limited to folding chairs, arm chairs, gaming chairs, massage chairs, motor vehicle seats, and office chairs. The examples of specific types of speakers or other transducers and their positions, as described with regard to FIGS. 1-5, are to be non-limiting. That is, the transducers may be of any type whether shakers or speakers, and whether capable of emitting high or low frequency vibrations. The term speaker may be replaced by the term shaker, and the term shaker may be replaced by the term speaker. Other configurations not show in the figures are considered to be within the scope of embodiments of the invention. For example, adding more speakers or speakers in different positions in the chair is within the spirit and scope of embodiments of the present invention.

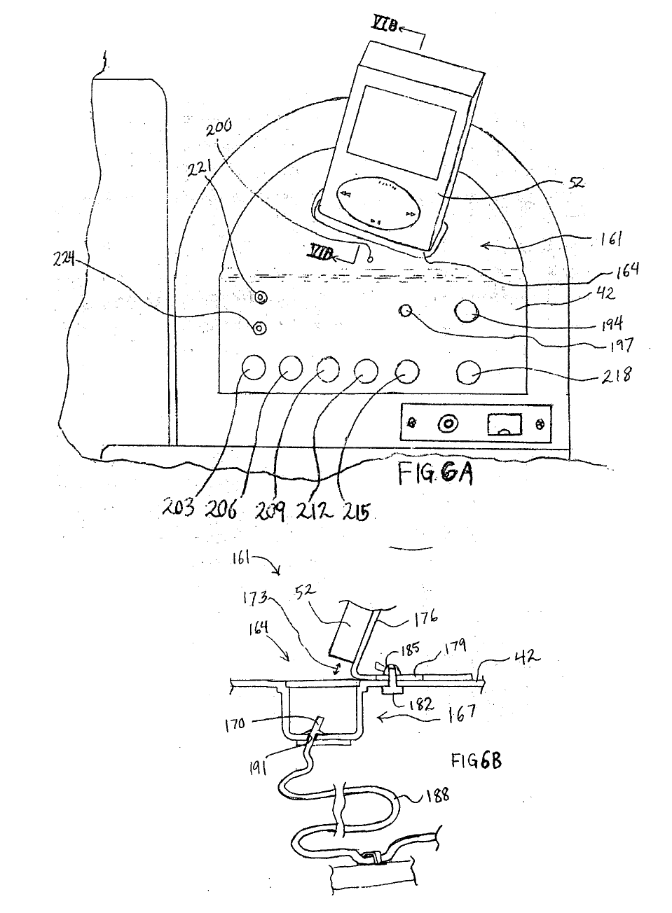

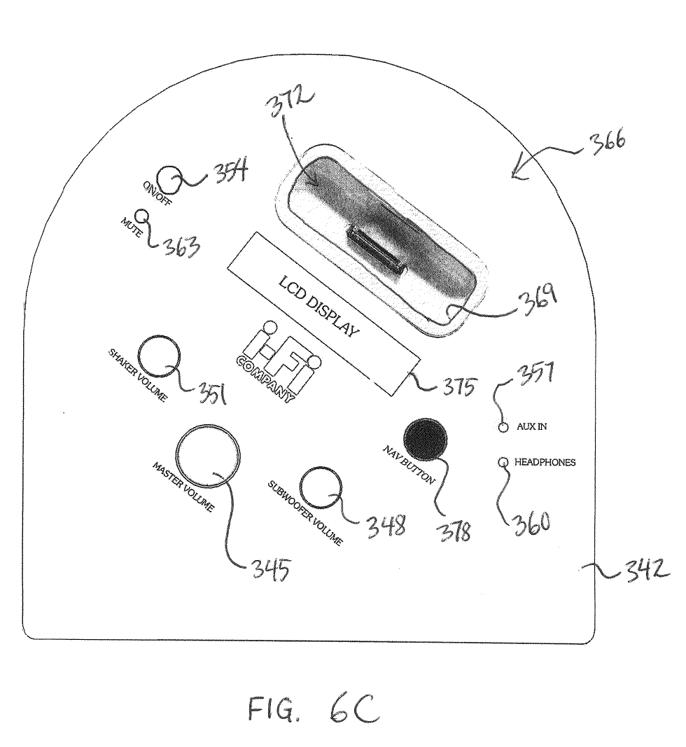

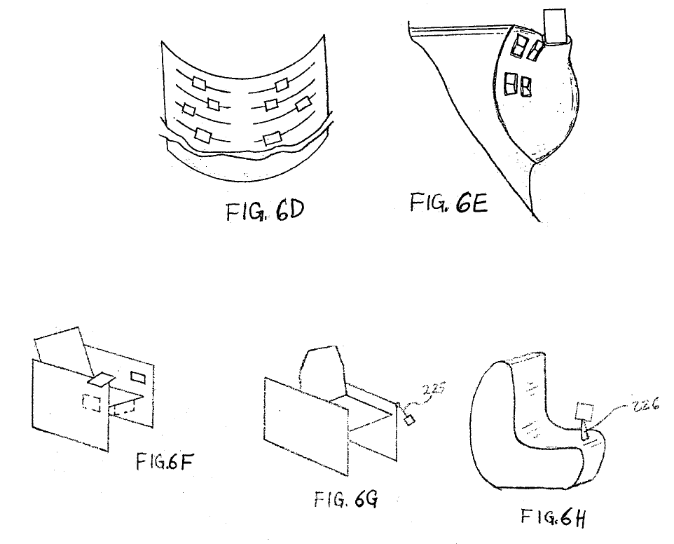

FIG. 6A is a detailed top plan view of a portion VI indicated in FIG. 1, and shows the control panel or platform 42 with greater specificity. The control panel 42 includes a docking station 161 for a personal electronic device 52, which, in the example illustration, is shown as an iPod. The docking station 161 may have a platform 42 with a relatively flat configuration, and the platform 42 may have a sync 167 for an iPod or other personal electronic device 52 supported on the platform 42. In one embodiment, however, the platform 42 has a recess 164, and the sync 167 is disposed in the recess 164, as illustrated in the sectional view of FIG. 6B taken along line VIB-VIB of FIG. 6A.

As shown in FIG. 6B, the sync 167 includes an electronics connector 170 that receives an iPod or other personal electronic device 52 for charging and transmission of signals to and/or from the audio system of embodiments of the present invention. The electronics connector 170 may be a multi-pin or other connector that is capable of being coupled to existing or future ports in personal electronic devices 52. As indicated by the double headed arrow 173, the personal electronic device 52 is removable, and can be docked and removed from the docking station 161.

In an embodiment of the invention, the docking station 161 is a universal docking station for personal electronic devices 52 of a variety of styles, shapes, and sizes. Therefore, the docking station 161 may include an adjustable support 176 that is slidably coupled to the platform 42. As shown, the slidable connection may include a slot 179 in the adjustable support 176, a part of a fastener such as a bolt 182 fixed to the platform 42, and another part of the fastener such as a wing nut 185 received on the bolt 182. Thus, the adjustable support 176 can be slid fore and aft to accommodate any of a variety of personal electronic devices 52 connected to the sync 167, which variety of personal electronic devices may have a variety of thicknesses and other sizing requirements that necessitate adjustment of the adjustable support to securely protect the connection. The wing nut 185 can be tightened on the bolt 182 to cause a clamping action on a base of the adjustable support 176 to hold the adjustable support 176 in a position that matches the size and shape of a particular personal electronic device 52. One or more of the recess 164, the personal electronic device electronics connector 170, and the adjustable support 176 forms a generally cantilever support that orients and holds a personal electronic device 52 in a generally upright position. The upright position includes extending upwardly and forwardly from the platform 42, as shown in FIGS. 6A and 6B.

Other structures may be incorporated in addition to or in place of those described here for supporting one or more of a variety of personal electronic devices 52. For example, one or more removable plugs or filler sockets having recesses 164 for devices 52 of specific sizes could be provided. Alternatively, a retractable and/or adjustable support could be stored in the platform 42 and deployed when supporting a personal electronic device 52. Also, although the personal electronic device 52 is shown as being supported in a lengthwise upright orientation, the recess 164 could be configured to accommodate devices 52 in lengthwise reclined or other orientation without limitation.

As shown in FIG. 6B, in one embodiment, the electronics connector 170 of the sync 167 may be detachably supported on the platform 42. The electronics connector 170 may be withdrawn from a stowed condition shown in FIG. 6B to a deployed condition by pulling a stem of the connector 170 from an opening 191 in the platform 42, and thereby releasing the connector 170 from a friction fit or other releasable connection to the platform 42. In this embodiment, a retractable line 188 forms a flexible tether with the electronics connector 170 at its distal end. The retractable line 188 can be moved out from an interior of the arm 17 through an opening 191. Thus, if a personal electronic device 52 does not fit in the recess 164, or if a user wants to connect a device remotely, the line 188 can be extended to a location and orientation other than a specific position on the platform 42.

Referring back to FIG. 6A, the platform 42 has a power button 194 for turning an audio system associated with the chair 14 on and off. The platform also has a channel selection button 197 for selecting a different channel in the case where the transmitter on a home entertainment system has interference from other signals, for example. An indicator light 200 indicates when a personal electronic device 52 has been connected to the electronics connector and is charging. Other controls are disposed on the platform 42, including a subwoofer volume control knob 203, a subwoofer frequency control knob 206, a shaker volume or amplitude control knob 209, a shaker frequency control knob 212, and a satellite volume control knob 215. These controls enable separate or independent control of each of the subwoofer 128, shaker 149, and mid-range/tweeter speakers 82, 83. The subwoofer 128 is controlled by knobs 203, 206. The shaker 149 is controlled by knobs 209, 212, and the mid-range and/or tweeter speakers 82, 83 are controlled by knob 215. The frequency control knobs 206 and 212 control a maximum frequency that will be transmitted to the subwoofer 128 and the shaker 149, respectively. In this way, a seat occupant can select a level of frequencies below which each of the subwoofer 128 and shaker 149 will transmit vibrations based on the signal being received by the audio system. The seat occupant can also independently select the volume or amplitude of the vibrations to be delivered by the subwoofer 128 and the shaker 149 by adjusting the knobs 203 and 209, respectively. The seat occupant adjusts the volume of the mid-range and/or tweeter speakers 82, 83 through adjustment of the knob 215, and the frequencies for these speakers 82, 83 may be limited by the capacity of the speakers 82, 83 themselves. Alternatively, a frequency control for the speakers 82, 83 may be included.

FIG. 6A also shows a mode selection knob 218 that enables the seat occupant to adjust a mode of operation of the sound system between personal electronic device mode, wireless mode, and auxiliary mode, for example. Other modes are also available, and all or part of this feature may be applied to a control panel or platform of any configuration. When a seat occupant wishes to wirelessly connect to a radio, television, or other home entertainment device he or she can switch the knob 218 to the wireless mode in which a receiver in the audio system of the chair 14 receives the signals and produces sounds corresponding to the signals. When a seat occupant wishes to play music or other recordings from an MP3 player, DVD player, or other device through a wired connection, the device can be connected through an auxiliary input 221 and the knob 218 can be switched to the auxiliary mode. In the auxiliary mode, the auxiliary device is connected to and transmits its signals to the audio system of the chair 14 for high quality audio production. When a seat occupant wishes to utilize an iPod or other personal electronic device 52, he or she can dock the device 52 in the docking station 161 and turn the knob 218 to the personal electronic device mode for transmission of signals from the device 52 to the audio system of the chair 14. In any of these modes a user may choose to utilize head phones that can be plugged into the headphone jack 224.

FIG. 6C is a diagrammatic top plan view of a platform 342 in accordance with an alternative embodiment of the present invention. Functionality similar to that described above is achieved with the combination of controls shown on the platform 342. Additionally, a master volume knob 345 controls the magnitude of all the transducers together. Subwoofer volume knob 348 and shaker volume knob 351 control respective volumes of the subwoofer and shaker transducers/speakers. Like the embodiment of FIGS. 6A-6B, a power button 354, auxiliary input 357, and head phone jack 360 are provided and have similar functionality. Platform 342 also has a mute button 363 to interrupt transmission of signals to the transducers. A docking station 366 with its recess 369 and sync 372 for a personal electronic device may also be substantially the same as those shown and described herein. The platform 342 also has a display screen 375 and an navigation button 378 for selecting among a plurality of modes that are displayed as a user scrolls by shifting the navigation button right, left, up, or down. The user also selects a mode by pressing the button toward a face of the platform 342. The navigation button 378 is also used to select a transducer or a group of transducers for adjustment. For example, the navigation button may be tilted left to select the shaker. Then the navigation button 378 may be tilted forward or aft to increase or decrease an upper limit for frequency signals to be directed to the shaker. Likewise, the navigation button 378 may be tilted right to select the subwoofer speaker(s). Then the user may tilt the navigation button forward or rearward to select a maximum frequency or a frequency range for the subwoofer speakers. Like adjustments may be similarly made for other transducers by viewing the screen 375, scrolling, and selecting options. Additional or alternative controls are possible, as suggested by the description of the following embodiments.

FIG. 6D-6H are diagrammatic perspective views showing a variety of alternative control panel configurations, control panel locations, and combinations of locations in accordance with alternative embodiments of the present invention. In the alternative embodiments, the control knobs may be replaced by sliding buttons as shown in FIG. 6D, or rocker switches as shown in FIG. 6E. It is to be understood that the control panel or platform need not be relatively flat like those shown in FIGS. 1-4 and 6A-6C. Also, the control panel or platform need not be positioned forward and below an armrest portion of a chair. Rather, the platform may be rounded in any of a variety of configurations, non-limiting examples of which are shown in FIGS. 6D and 6E. Locations for the control panel may include an inner surface or outer surface of an arm, as indicated by solid and dashed parallelograms shown in FIG. 6F. The controls may be split among a plurality of control panels, and the one or more control panels may be additionally or alternatively located on top of an arm or under a front edge of seat bottom as indicated by the additional solid and dashed parallelograms in FIG. 6F. In another alternative embodiment, the control panel may be adjustably supported on an adjustable support 225, as shown in FIG. 6G. Thus, the control panel may be selectively stowed and deployed, and may be adjustable to any position of use. Further alternatively, the controls may be disposed on a control panel or platform supported on a post 226 that is to be straddled by the legs of the seat occupant such as in a game chair, as shown in FIG. 6H.

The configurations shown in FIGS. 6A-6H are examples only, and the controls or control panels or platforms may be provided at any other location on or near a chair, and may be applied with any of a variety of chair styles and configurations. Any of these panels may include a personal electronic device sync, which may include one or more features of the syncs and docking stations described with regard to other embodiments herein. On the other hand, one or more of the features of the other embodiments of syncs and docking stations may be incorporated into the embodiments of FIGS. 6A-6G. Further alternatively, a remote control wand could include control buttons, knobs, and/or switches for wireless connection to the personal electronic devices, audio system, and/or auxiliary devices associated with the audio systems in accordance with embodiments of the invention. Further alternatively, the control may include a wired or tethered remote control wand.

While FIG. 6A shows a volume control knob and frequency control knob for each of the subwoofer and shaker, it is to be understood that similar pairs of knobs may be provided for any number of speakers whether they be woofers, subwoofers, shakers, tweeters, or midrange speakers. Also, a combination of a fade adjustment between two or more speakers may replace the function of the volume control. In this way, a fader and frequency control for any speaker can be used to adjust both amplitude and a maximum frequency in accordance with an embodiment of the present invention. In one embodiment, frequency adjustment mechanisms with which a user may select a specific range of frequencies can be implemented. Touch screen controls, clickable soft buttons, stylus engagable controls, and any other user interface mechanisms for adjusting at least one of an amplitude and a frequency or range of frequencies are within the spirit and scope of embodiments of the present invention.

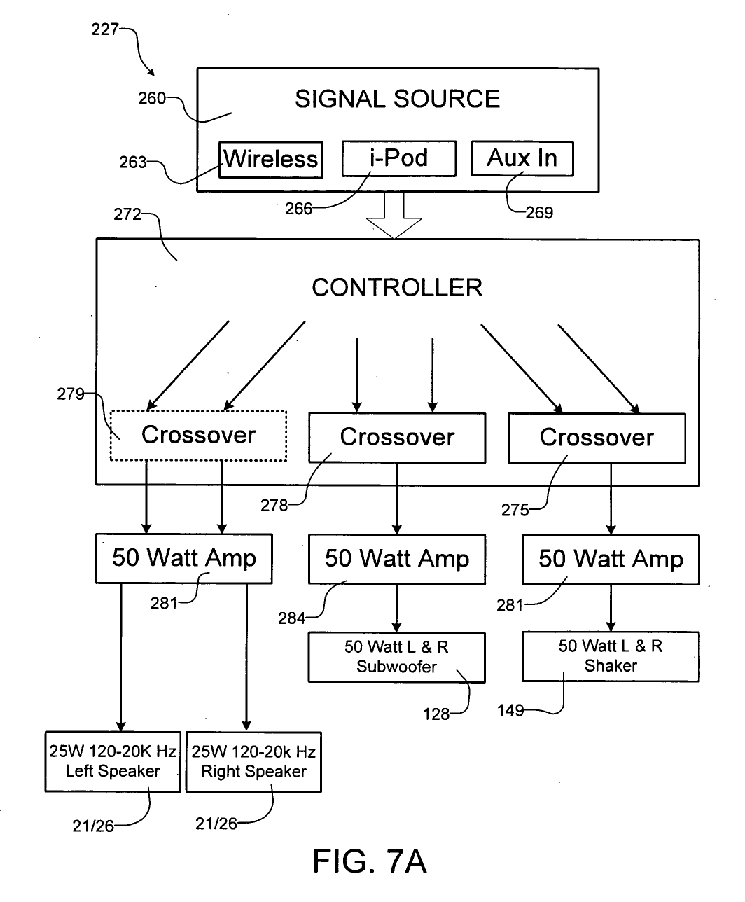

FIG. 7A shows a block diagram of an example of a 2.2 audio system 227 illustrating some basic elements and their relationships with each other. As shown, there is a signal source 230, which may include at least one of a wireless input 233, an iPod input 236 by way of a connected iPod, and any of a variety of auxiliary inputs 239. A source signal from these inputs is received in a controller 242 that processes the source signal and coordinates the function of the components that make up the audio system 227. The controller 242 is configured maintain at least a portion of the source signal as a stereo signal with no frequency limits imposed. That is, this portion of the source signal may be left as a full bandwidth signal. The controller at least one of maintains the stereo signal as left and right separate signals or separates it from a mono signal into two signals for left and right mid/high range speaker units. These stereo signals are prepared for a differential amplifier. The controller 242 also separates two additional signals from the source signals and sums them together for two respective mono amplifiers with the aid of two variable digital crossovers 245, 248. The two additional source signals may be separated by respective ones of the digital crossovers 245, 248. A first of the crossovers 245 may be adjusted to separate signals having frequencies in a range from 20 Hz to 80 Hz. If the source signal has signals in this range separated for left and right speakers, for example, the variable crossover 245 and/or other component(s) sums these signals for a mono signal having frequencies in this range. A second of the crossovers 248 may be adjusted to separate signals having frequencies in a range from 80 Hz to 220 Hz. If the source signal has signals in this range separated for left and right speakers, for example, the variable crossover 248 and/or other component sums these signals for a mono signal having frequencies in this range. In one embodiment, another variable crossover 249 may be applied to the satellite signals. Other mechanisms such as filters may be incorporated in addition to or in place of the digital crossovers for separating the signals.

Once the stereo and mono signals have been separated, the stereo signals are sent to a differential amplifier 251, and the mono signals are sent to respective mono amplifiers 254 and 257. These signals are adjustably amplified in the amplifiers 251, 254, and 257 for the mid/high range satellite, subwoofer, and shaker speakers/transducers, respectively. In the separated state, power is added to the signals and the signals are transmitted to the speakers/transducers 21, 128, and 149 for a high quality sound delivered selectively to predetermined portions of a body of a seat occupant.

Variations on the system 227 may form the various embodiments of the present invention. The audio systems referred to herein may include a variety mechanisms including electronic devices, switches, and mechanisms for coordinating the various functions described. These mechanisms may be in the form of circuitry on a printed circuit board, micro chip, and/or other electronics circuits. For example, the subwoofer 128 and the shaker 149 may each be connected to a separate frequency range adjustment device and a separate volume control device and may be controlled by the knobs 203, 206, 209, and 212. By these connections, devices, and controls, each of a shaker frequency range adjustment mechanism, a shaker volume adjustment mechanism, a subwoofer frequency range adjustment mechanism, and a subwoofer volume adjustment mechanism is provided such that the subwoofer 128 and the shaker 149 are separately tunable and adjustable. Other shaker, subwoofer, woofer, midrange, and tweeter speakers may be similarly separately adjusted.

Unlike conventional systems, each of the speakers, subwoofers, and shakers is independently crossed over and powered and receives a signal associated with a particular channel in order to achieve the separately tunable and adjustable configuration. A stereo signal is received from a digital source such as a CD or DVD. Alternatively, a multi-channel signal that is adapted for a multi-speaker system such as a 5.1 system, for example, is received. Instead of sending the signal to a digital to analog converter, the circuitry in embodiments of the present invention separate the signal into customized signals for each of the speakers, subwoofers, and shakers to which they will be sent. The customized signals are sent to respective amplifiers within the circuitry before being sent to the respective speakers, subwoofers, and shakers. Power to these speakers, subwoofers, and shakers is delivered separately from the customized signals. The separation and customization of the customized signals includes implementing separations based on one or more crossovers. In a 2.2 system, for example, there are two crossovers, one between the shaker and the subwoofer frequency ranges, and the other between the subwoofer and the midrange/tweeter speaker frequency ranges. Filters in the circuitry may separate signals between 0 and 40 hertz for the shaker, signals between 40 and 100 hertz for the subwoofer, and signals above 100 hertz for the midrange/tweeter speakers in this example. Separate controls for each of frequency and volume in the circuitry for each of the speakers, subwoofers, and shakers is controlled by a pair of knobs or other controls for each transducer. In order to achieve the customization, embodiments of the present invention also have circuitry elements that combine stereo signals for one or more subwoofer and shaker into mono signals before performing the separation for the subwoofer and shaker.

Once again, the speakers, subwoofers, and shakers in accordance with embodiments of the present invention are each separately powered as well as receiving their own customized amplified signal. In a 2.2 system, for example, the midrange/tweeter speakers may each be given a capacity of 25 Watts where the stereo signal was prepared for a 50 Watts stereo set of midrange/tweeter speakers.

Where there is typically cross-talk in the conventional multispeaker systems, embodiments of the present invention divide the signals into discrete customized signals such as four discrete signals for a 2.2 system. The power component is not added to these customized signals until they are separated by frequency in a digital crossover. Thus, cross-talk is avoided. With proper placement of the speakers, subwoofers, and shakers, an extremely transparent sound is achieved. Because of the differentiation of the signals sent to each of the speaker units and to each of the subwoofers/shakers, the systems in accordance with embodiments of the present invention may be termed dual differential systems.

Conventional audio systems such as 5.1 systems take a stereo source signal from a CD, for example, and place intentional offsets in the signals so that the sound from each of the five speakers is not purely redundant. When the source to the 5.1 system is from a DVD, the signals are separated for the five speakers. However, for both of these sources, offset signals and the already separated signals are typically powered and are subject to cross-talk.

A 5.1 system is designed for a sound system of a room or theater and is typically not well suited for a sound system in a chair. When signal sources designed for conventional stereo or multi-speaker systems are applied to speakers in a chair without being modified in accordance with embodiments of the present invention, the result is an acoustically garbled output. Furthermore, the placement of the speakers at a position that is horizontal or slightly above a head and/or ears of a seat occupant is beneficial and allows the listener to perceive visual cues or imaging of the sonic event, placing instruments and voices as if coming from a stage and giving the listener a reasonable facsimile of where sounds should be placed from right to left and back to forward on the stage. For viewing capabilities the speakers may also be placed at approximately thirty degrees from straight in front of the head of the seat occupant and the faces of the speakers may face the head of the seat occupant.

FIG. 7B is a detailed perspective view of a portion IV indicated in FIG. 1, as viewed by a seat occupant in a direction of arrow 230 in FIG. 1. The personal electronic device docking station 161 with platform 42 and sync 167 may thus be applied to a comfortable armchair or overstuffed chair or sofa. The chair 14 is a high fidelity audio chair that also has structure including a frame and cushioning material that form ergonomic armrests and hand rests 233. The ergonomic hand rest 233 includes a contour provided at least in part by the frame members and cushioning material that form a rounded forward edge 236 of an armrest portion of the arms 17 and 18, as shown in FIGS. 1 and 7B. The ergonomic hand rest 233 may also include at least a portion of the platform 42 with its docking station 161 and controls. The platform 42 is adjacent to an upholstered portion of one of the armrests or hand rests 233 of the chair 14. A cushioning material 70 may include a stuffing material in the upholstered portion. The upholstered portion forms the rounded portion of the ergonomic hand rest 233 that extends downward and forward to the platform 42.

The relationship of the platform 42 and the front edge 236 of the armrest portion of the arm 17 allows a hand 239 of a seat occupant to lie comfortably with the fingers extending over the edge 236 toward the platform 42. In this position, the wrist and hand extends generally straight forward in alignment with the forearm of the seat occupant so that there is no strain on the wrist or forearm. In this position, the seat occupant has ready and easy access to the controls and sync 167. The ergonomic configuration enables fingertip manipulation of the knobs 203, 206, 209, 212, 215, 218, the personal electronic device 52, and associated components. For example, the seat occupant can easily control recorded media on his iPod or other device 52 by engaging controls 242 on the device 52 with his or her finger 245. The adjustable support 176 (see FIG. 6B) supports the personal electronic device 52 at an angle that allows the seat occupant to view the screen 248 without strain to the eyes or neck. The support 176 also protects against inadvertent damage to the electronics connector 170 of the docking station 161, as described above, and allows the seat occupant to engage the controls 242 of the device 52 without fear of damaging the electronics connector 170.

In alternative embodiments, the hand rest and/or armrest is not necessarily ergonomic. Embodiments of the invention include, for example, the controls placed in a position that is not necessarily comfortable or convenient. One or more other features of the embodiments of the present invention may be incorporated into a chair. Similarly, the Chair itself may not be a particularly comfortable chair. For example, the chair may be any of a variety of chairs including folding chairs, rigid chairs, rocking chairs, theatre chairs and other chairs. The sound system in accordance with embodiments of the present invention may be incorporated into any of these chairs. Further alternatively, the chair may be a gaming chair and may have a configuration and structure similar to that which is shown in FIG. 6H. The chair may or may not include arms. Some of the styles of chairs with which embodiments of the present invention may be implemented are suggested in the schematic views shown in FIGS. 3B, 6C-6H, and 8A-8E.

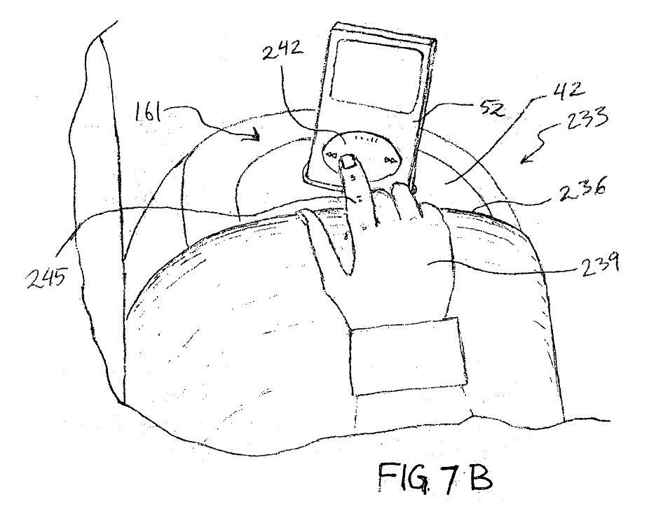

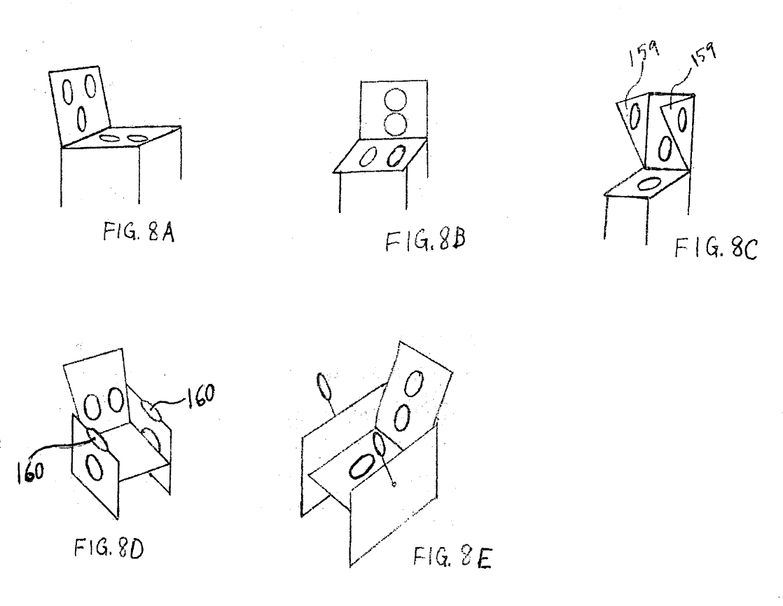

FIGS. 8A-8E are diagrammatic perspective views showing a variety of example speaker positions and combinations of positions in accordance with embodiments of the present invention. FIG. 8A shows three speakers or other transducers in the backrest at shoulder and lower back positions, and two speakers or transducers aligned in a generally fore and aft direction in the seat bottom. FIG. 8B shows two speakers or other transducers aligned in a generally vertical direction in the backrest, and two speakers or other transducers laterally aligned in the seat bottom. FIG. 8C shows the speakers or other transducers generally in the positions of the subwoofer and shaker of FIG. 2, and further includes speakers or other transducers in wings 159. It is to be understood that the transducers in the wings 159 may include one or more transducer of the tweeter, midrange, woofer, subwoofer, and shaker types. FIG. 8D shows two speakers or other transducers laterally aligned in the backrest, and a speaker or other transducer in each of a pair of opposite arms of the chair. These speakers may be in addition to tweeters and/or midrange speaker units 160 shown in an upper portion of the arms. The speakers 160 may be provided as speaker units supported statically and/or adjustably in accordance with one or more of the teachings of the embodiments of FIGS. 1-7B. FIG. 8E shows another combination of speakers, and includes a configuration for adjustable speakers supported on the arms similar to the embodiment of FIG. 3B.

It is to be understood that a chair in accordance with the embodiments of the present invention may take any form including, but not limited to folding chairs, arm chairs, gaming chairs, massage chairs, motor vehicle seats, and office chairs. The examples of specific types of speakers or other transducers and their positions, as described with regard to FIGS. 1-8E, are to be non-limiting. That is, the transducers may be of any type whether shakers or speakers, and whether capable of emitting high or low frequency vibrations. The term speaker may be replaced by the term shaker, and the term shaker may be replaced by the term speaker. Likewise, the terms speaker and electro-magnetic transducer (or transducer) as used herein are interchangeable. Volume adjustment and adjustment of a magnitude of vibrations in the transducers refer generally to the same effect and are used interchangeably. Any of the configurations, combinations of configurations, or parts of the configurations shown in FIGS. 8A-8E may be applied to the embodiments of FIG. 1-7B. Any of the details of other embodiments within this disclosure may be applied to the embodiments of FIGS. 8A-8E. Furthermore, any feature of any of the embodiments may be combined with other features of any of the other embodiments without limitation. Other configurations not show in the figures are considered within the scope of embodiments of the invention. For example, adding more speakers or speakers in different positions in the chair is within the spirit and scope of embodiments of the present invention.

It is to be understood, that for purposes of this disclosure, the terms entertainment chair and audio chair are used interchangeably. Such chairs form speaker units or speaker cabinets that also support a human body. Thus, these entertainment chairs have an advantage of locating speakers and other transducers that transmit vibrations in a variety of frequency ranges to predetermined areas of the body of a chair occupant.

The present invention may be embodied in other specific forms without departing from its spirit or essential characteristics. The described embodiments are to be considered in all respects only as illustrative and not restrictive. The scope of the embodiments of the invention is, therefore, indicated by the appended claims rather than by the foregoing description. All changes which come within the meaning and range of equivalency of the claims are to be embraced within their scope.

What is claimed is:

1. A high fidelity audio chair, comprising:
one or more of tweeter speakers and midrange speakers supported on the chair;
a seat bottom with a shaker positioned in the seat bottom; and
a backrest with a subwoofer in the backrest;
wherein the speakers, shaker, and subwoofer form a 2.2 audio system.

2. The high fidelity audio chair of claim 15, wherein the shaker and the subwoofer are separately tunable.

3. The high fidelity audio chair of claim 16, wherein the shaker and the subwoofer are each connected to a separate frequency range adjustment device and a separate volume control such that the shaker and the subwoofer are separately tunable and adjustable.

4. A high fidelity audio chair comprising:
a pair of chair arms;
a speaker cabinet in each of the pair of chair arms; and
at least one of a tweeter and midrange speaker in the speaker cabinet.

5. The high fidelity audio chair of claim 4, wherein the speaker cabinet is configured to support the speaker with its face directed diagonally upward and inward in a plane adjacent to and in front of a seat occupant's face.

6. The high fidelity audio chair of claim 4, wherein the speaker cabinet is configured to support the speaker with its face directed upward, inward and back generally directed toward at least one of the seat occupant's face and the seat occupant's ears.

7. A high fidelity audio chair, comprising a speaker support configured to direct a face of a speaker at least one of upward and inward.

8. The high fidelity audio chair of claim 7, wherein the speaker support is configured to also direct the face of the speaker rearward.

9. The high fidelity audio chair of claim 7, wherein the speaker support is adjustable.

10. The high fidelity audio chair of claim 7, wherein the speaker support is adjustably mounted on an armrest of the chair.

11. The high fidelity audio chair of claim 7, wherein the speaker support is removably mounted on an armrest of the chair.

12. The high fidelity audio chair of claim 11, further comprising an enclosure in the chair, wherein the speaker support is removably stowed in the enclosure for retrieval and deployment on the armrest of the chair.

13. The high fidelity audio chair of claim 11, further comprising:
a receiver on the armrest for receiving the speaker support;
a speaker, speaker cord, and jack supported on the speaker support; and
an electrical connector on the armrest proximate to the receiver, the electrical connector configured to receive the speaker jack when the speaker support is in a deployed condition in the receiver.

14. The high fidelity audio chair of claim 13, wherein the speaker support is a first removable speaker support having a first speaker supported thereon, the chair further comprising:
a second integral speaker support integral with the armrests and having a second speaker supported therein; and
a switching device coupled to at least one of the receiver and electrical connector, the switching device configured to be automatically activated when the first removable speaker support is in the deployed condition, wherein the first removable speaker support is deployed when at least one of the first speaker support is inserted in the receiver and the jack is inserted into the electrical connector;
the switching device configured to be automatically deactivated when at least one of the first speaker support is removed from the receiver and the jack is removed from the electrical connector;
wherein the switching device connects the first speaker to a control system when the first speaker support is supported in the receiver, and the switching device connects the second speaker to the control system when the first speaker support is removed from the receiver.

15. A high fidelity audio chair, comprising:
structure including a frame and cushioning material, wherein:
the structure forms ergonomic armrests and hand rests;
the ergonomic hand rests include a personal electronic device docking station; and
the docking station has a deck with an electronics connector supported on the deck.

16. The high fidelity audio chair of claim 15, further comprising an adjustable support coupled to the platform.

17. The high fidelity audio chair of claim 16, wherein the adjustable support is slidably coupled to support any of a variety of personal electronic devices connected to the electronics connector.

18. The high fidelity audio chair of claim 16, further comprising a recess in the deck, wherein at least one of the recess in the deck, the electronics connector, and the adjustable support forms a generally cantilevered support that orients and holds a personal electronic device in a generally upright position.

19. The high fidelity audio chair of claim 15, wherein the deck is proximate to an upholstered portion of at least one of the armrests and the hand rests of the chair, and the upholstered portion forms a rounded ergonomic hand rest that extends downward and forward to the deck.

20. The high fidelity audio chair of claim 15, further comprising controls disposed on the platform, wherein the controls include a shaker frequency range adjustment mechanism, a shaker volume adjustment mechanism, a subwoofer frequency range adjustment mechanism, and a subwoofer volume adjustment mechanism.

21. The high fidelity audio chair of claim 15, wherein the high fidelity chair comprises at least one of a comfortable armchair, an overstuffed chair, and a sofa.
